(19) United States
(12) Patent Application Publication
(10) Pub. No.: US 2011/0012725 A1
(43) Pub. Date: Jan. 20, 2011

(54) Brake light flashing device

(76) Inventor: Jimmy Foreman, England, AR (US)

Correspondence Address: LAW OFFICE OF KYLE FLETCHER, P.O. Box 11735, CHARLOTTE, NC, 28220, US

(21) Appl. No.: 12/503,343

(22) Filed: Jul. 15, 2009

(51) Int. Cl. B60Q 1/46

(52) U.S. Cl. 340/467

(57) ABSTRACT

The brake light flashing device includes an RPM sensing/setting device that monitors the RPMs of an engine to determine whether an accelerator pedal has been released in anticipation of depression of a brake pedal. The RPM sensing/setting device is in turn wired to an in-line fuse, and a flashing device, which flashes an after-market brake light as well as pre-existing brake lights.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to the field of brake light flashing mechanisms, more specifically, a brake light flashing mechanism that flashes the brake lights when the accelerator pedal is released in anticipation of depression of the brake pedal, and of which monitors the rpm's of the engine to determine when to flash the-brake lights.

B. Discussion of the Prior Art

As a preliminary note, it should be stated that there is an ample amount of prior art that deals with brake light flashing mechanisms. As will be discussed immediately below, no prior art discloses a brake light flashing mechanism that flashes the brake lights when the accelerator pedal is released, which is monitored via the RPMs of the engine.

The Kao Patent (U.S. Pat. No. 7,088,228) discloses a system for generating a warning light on a vehicle when the accelerator pedal of the vehicle is released by the driver. However, the warning light is a light in addition to the brake lights of the vehicle; and further requires a rack to attach onto said accelerator pedal as opposed to a sensor that monitors the RPMs of the engine, and of which flashes the brake lights.

The Boomershine, III Patent (U.S. Pat. No. 7,154,387) discloses a deceleration warning system for a vehicle. However, the warning system is housed in a license plate bracket, and does not flash the brake lights upon release of the accelerator pedal via a sensor that monitors the RPMs of the engine.

The Carlson et al. Patent (U.S. Pat. No. 6,911,905) discloses a deceleration warning system for a vehicle in which flashing brake lights are illuminated to warn other drivers of a decelerating condition. However, the warning system does not involve a sensor that senses the RPMs of the engine to determine if the accelerator pedal has been released.

The Zimmerman Patent Application Publication (U.S. Pub. No. 2006/0125617) discloses a system for activating the brake light of a vehicle in response to a driver of the vehicle relaxing pressure on the accelerator pedal. However, the system involves the use of a strain gage to determine the amount of pressure on the accelerator pedal as opposed to a sensor that monitors the engine's RPMs.

The Liljequist Patent (U.S. Pat. No. 3,332,060) discloses another vehicle deceleration warning system. However, the system involves the use of freely moveable mass forming an electrical bridge thereby varying the current flow, and does not use a sensor to monitor the RPMs of a car to sense whether the accelerator pedal has been released.

While the above-described devices fulfill their respective and particular objects and requirements, they do not describe a brake light flashing device that includes an rpm sensing/setting device that monitors whether the accelerator pedal has been released. In this regard, the brake light flashing device departs from the conventional concepts and designs of the prior art.

### SUMMARY OF THE INVENTION

The brake light flashing device includes an RPM sensing/setting device that monitors the RPMs of an engine to determine whether an accelerator pedal has been released in anticipation of depression of a brake pedal. The RPM sensing/setting device is in turn wired to an in-line fuse, and a flashing device, which flashes an after-market brake light as well as pre-existing brake lights.

It is an object of the invention to provide a brake light flashing system that flashes the brake lights upon release of an accelerator pedal in order to warn drivers from behind said vehicle of an impending deceleration.

A further object of the invention is to provide a brake light flashing system that involves an rpm sensing/setting device that monitors the RPMs of a vehicle to determine whether the accelerator pedal has been released in anticipation of depression of the brake pedal.

It is a further object of the-invention to provide a brake light flashing system that can be installed upon an existing vehicle or integrated into the design of a new vehicle.

A further object of the invention is to provide a brake light flashing system that is easy to install, easy to use, affordable, and effective.

These together with additional objects, features and advantages of the brake light flashing device will be readily apparent to those of ordinary skill in the art upon reading the following detailed description of presently preferred, but nonetheless illustrative, embodiments of the brake light flashing device when taken in conjunction with the accompanying drawings.

In this respect, before explaining the current embodiments of the brake light flashing device in detail, it is to be understood that the brake light flashing device is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the brake light flashing device. It is therefore important that the claims be regarded as including such equivalent construction insofar as they do not depart from the spirit and scope of the brake light flashing device. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a side view of a vehicle wherein an RPM sensing/setting device is installed adjacent an engine, the vehicle's battery and accelerator pedal are depicted with wiring connecting an in-line fuse to existing brake lights and a 3^{rd} brake light;

FIG. 2 illustrates a diagram of the various components of the brake light flashing device as well as existing parts of the vehicle, which include the accelerator pedal, engine, and battery; and

FIG. 3 illustrates a rear view of a vehicle with the brake light flashing device installed as well as a 3^{rd} deceleration light, and a close-up view of an end user releasing an accelerator pedal thereby enacting the brake light flashing device.

### DETAILED DESCRIPTION OF THE EMBODIMENT

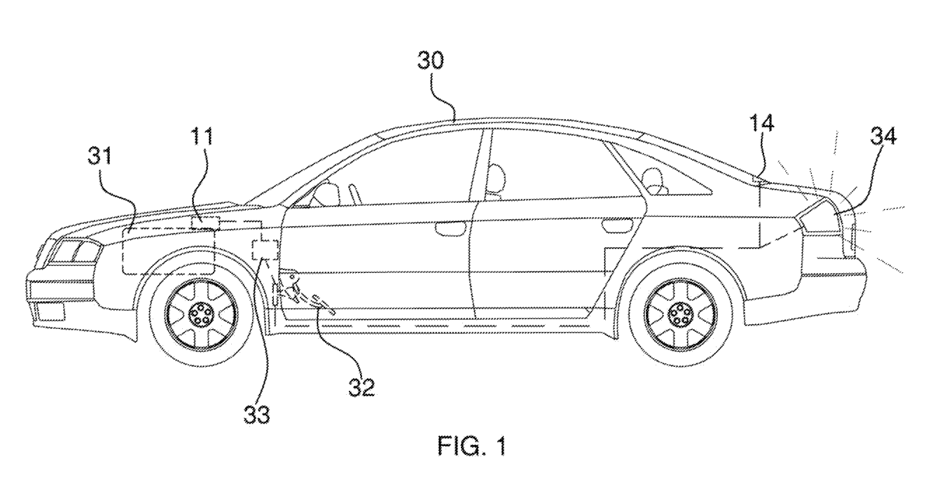

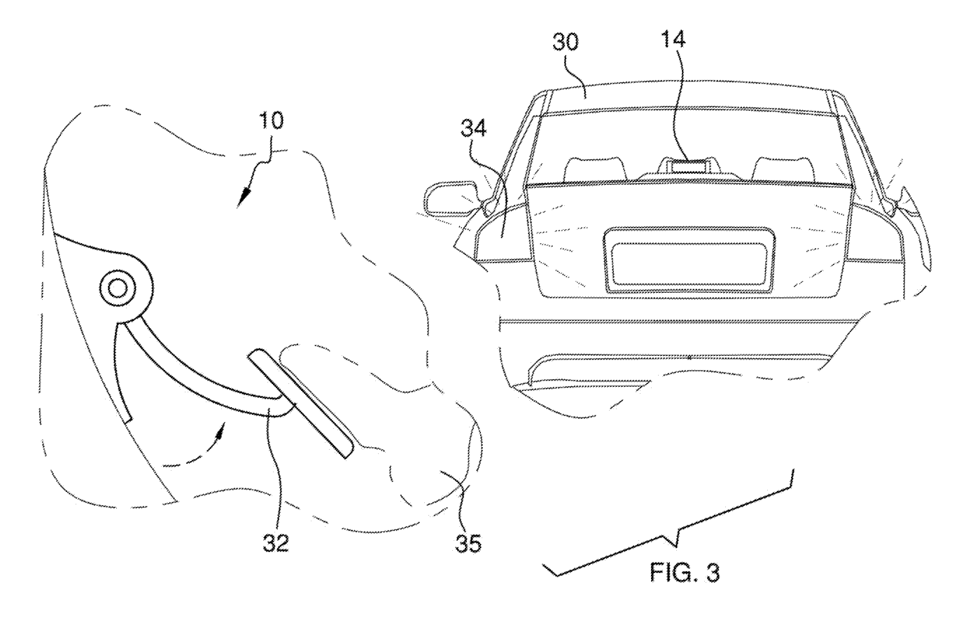

Detailed reference will now be made to the preferred embodiment of the present invention, examples of which are illustrated in FIGS. 1-3. A brake light flashing device 10 (hereinafter invention) includes an RPM sensing/setting device 11, a flasher 12, and an in-line fuse 13.

The invention 10 is either installed on a pre-existing vehicle 30 or designed in a new vehicle. The invention 10 is designed to work with an engine 31, an accelerator pedal 32, a battery 33, and brake lights 34.

The RPM sensing/setting device 11 monitors the RPMs of the engine 31, and is also wired to both the battery 33 and the—in-line fuse 13. The in-line fuse 13 is wired to the flashing device 12, which in turn controls the deceleration light 14 and/or brake lights 34.

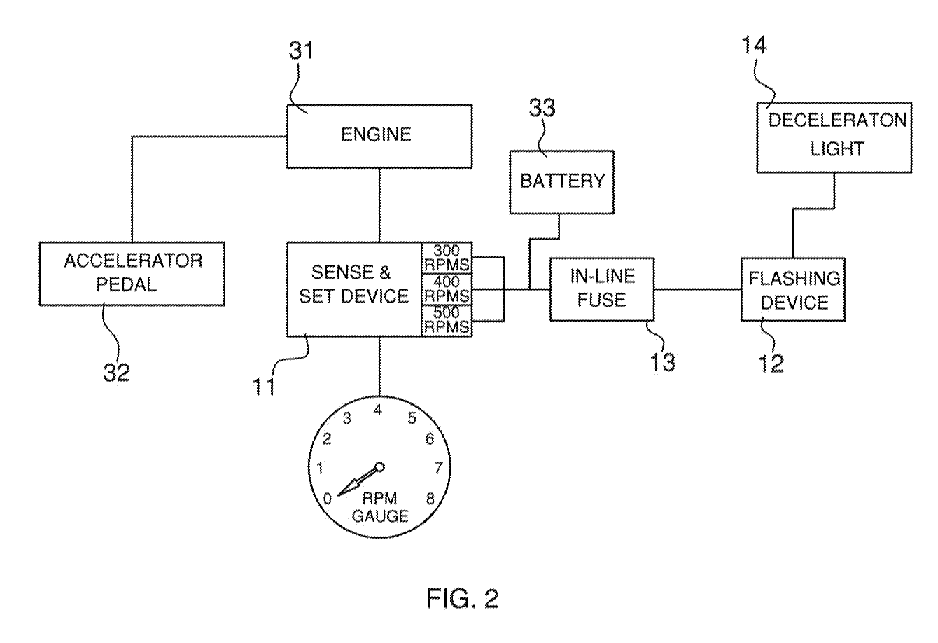

The RPM sensing/setting device 11 is designed to monitor the RPMs of the engine 31, in the same way a tachometer works. Additionally, the RPM sensing/setting device 11 can provide for variable settings that sense when the RPMs of said engine 31 fall below a certain pre-set value. An end user can specify that the RPM sensing/setting device 11 signal the flasher 12 once the RPM of the engine 31 falls below a specific RPM, which is depicted in FIG. 2 with boxes indicating 300/400/ and 500 RPMs.

For example, should an end user remove his/her foot 35 from an accelerator pedal 32, the RPM sensing/setting device 11 will calculate the drop in RPMs of the engine 31. If the drop in RPMs of the engine 31 is above a pre-determined value, the RPM sensing/setting device 11 will not signal the flasher 12. Alternatively, should the drop in RPMS of the engine 31 fall below a pre-determined value, the RPM sensing/setting device 11 will signal the flasher 12.

It shall be noted that the RPM sensing/setting device 11 will be available for setting at any RPM within range of what is capable by the engine 11.

The flashing device 12 will flash the deceleration light 14 and/or brake lights 34 for a plurality of times, which will notify motorists behind the vehicle 30 of an impending deceleration of the vehicle 30 via a brake pedal depression.

With respect to the above description, it is to be realized that the optimum dimensional relationship for the various components of the invention 10, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 10.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A brake light flashing device further comprising:
an RPM sensing/setting device that monitors the RPMs of the engine, and is wired to a flasher; wherein the RPM sensing/setting device can adjust a setting at which the RPM sensing/setting device will signal the flasher;
once the RPMs of an engine drop below said setting, the flasher is signaled, which signals a light located on a rear of a vehicle.

2. The brake light flashing device as described in claim 1 wherein said flash monitors wherein the flasher will flash said light a plurality of times.

3. The brake light flashing device as described in claim 1 wherein said adjustable setting can monitor all available RPMS of said engine.

4. The brake light flashing device as described in claim 1 wherein said flasher is wired to a third brake light or existing brake lights.

5. The brake light flashing device as described in claim 1 wherein an in-line fuse is installed between the RPM sensing/setting device and the flasher.

6. The brake light flashing device as described in claim 1 wherein the RPM sensing/setting device is wired to a battery of said vehicle.
